(19) United States
(12) Patent Application Publication
(10) Pub. No.: US 2020/0184496 A1
(43) Pub. Date: Jun. 11, 2020

(54) PSYCHOPHYSIOLOGICALLY ENHANCED FINANCIAL MARKET TRADING SYSTEMS AND SECURITIES EXCHANGES

(71) Applicant: Krunoslav Ken MEDANIC, Dubrovnik (HR)

(72) Inventor: Krunoslav Ken MEDANIC, Dubrovnik (HR)

(21) Appl. No.: 16/324,745

(22) PCT Filed: Aug. 11, 2016
(86) PCT No.: PCT/IB2016/054847

§ 371 Date: Feb. 11, 2019

(51) Int. Cl. G06Q 30/02; G06Q 40/04

(52) U.S. Cl. CPC G06Q 30/0202; G06Q 40/04

(57) ABSTRACT

Trading within the context of the financial markets is characterized by decisions that are made between buyer and seller that either conclude with a reward or loss. Thusly, trading can be considered a performance-based activity wherein one's success is directly impacted by one's performance. Like any other performance-based activity, trading can be negatively impacted by psychophysiological stress. The problem with conventional trading systems, securities exchanges and the methods and processes they employ is that they do not address the psychophysiological states of the participant and thusly ignore the impact stress can have on the trading process. This exemplary system facilitates improved decision making and mitigates loss during trading activities with the integration of non-invasive, psychophysiological, performance-enhancement tools and techniques embedded within a comprehensive trading and securities exchange system. The exemplary systems, methods, interfaces and software demonstrated herewith enhances the financial market decision making process for both the buyer and seller by quantifying their psychophysiological response to the opportunities and threats of the financial markets in real-time. This process of quantifying psychophysiological response serves to inform advanced decision making assessment, training, monitoring and evaluation toward the objective of attaining a state of consistent peak performance, thereby providing for improved real rates of return for traders, investors, portfolio managers and fund managers alike.

### COPYRIGHT NOTICE AND PERMISSION

### Clarification of Terms

The terms “trader”, “portfolio manager”, “money manager”, “fund manager” and “participant” will be used interchangeably in this document and will refer to anyone who makes decisions or plans to have decisions enacted for oneself or on behalf of other(s) in the greater context of the financial markets and associated products whether domestic, foreign or both and all terms stated above will include both masculine and feminine genders. Further, the terms “securities exchange”, “brokerage platform”, “trading platform” and “financial server” where securities whether real, derivative or cyber are exchanged between entities shall be interchangeable and mean and refer to the same method, system and process. Finally, the terms “security”, “financial instrument” and “economic instrument” shall be used interchangeably and will include in its' meaning terms such as “derivative”, “Stock”, “Bond”, “commodities”, “options”, whether real or cyber. All terms shall include both the plural and singular of its' definition.

### BACKGROUND

The exchange of an asset or liability (present or future) between one entity and another for consideration is the definition of a “trade”. This exchange requires a process of assessment and due diligence before an agreement of consideration is made.

Our earliest ancestors traded and exchanged by using a barter system. Much the same way, they too assessed the value of what they were being offered in exchange for what they were being asked to give up (trade). The effects of their trading activities very easily meant the difference between life and death. To trade a good fur covering with an impending winter could be a costly trade if there would be no other opportunities to hunt big game successfully. Skill, intelligence, instinct became the hallmarks of a successful trade even for our rudimentary ancestors. It was this ability to perform successfully which dictated survival and illustrated in our human species Darwin's theory of evolution.

We fast-forward to the 1970's and the advent of a global economy and the need to move large volumes of assets and liabilities to fuel global trade and expansion. With our growing sophistication as a society and species we developed an organized system of large scale exchange with the pit traders in the open-outcry system. An efficient means to manufacture and exchange financial products to bridge cultural gaps and improve international trade. With every trade in this vast and growing market place was a buyer and a seller. The buyer saw value in taking ownership and the seller saw value in releasing his claim. With each and every trade, with each and every exchange a decision was made whereby value was sought and intended by both buyer and seller. The seeking of value, the intention to receive value after the exchange did not connote nor assure that value would eventuate. Similarly, to our earliest ancestor, skill, intelligence and instinct became the hallmarks of a successful trader and investor. No greater venue has there been to demonstrate the full range of emotions which define humanities quest for survival then the hallowed trading pits of days gone by. A wonderfully rich source of data with which to map and better understand the decision making process and its' effects in the pursuit of prosperity within the confines of an environment where potential failure is a ready possibility. The daily adventures within such a milieu has lead every trader and investor since the dawn of time to ask the following questions; what defines a successful trade? What were the characteristics of a losing exchange? How can one tell the difference? What mistakes were made? What strategies lead to success? These enquiries and many more are being asked even more vigorously with the advent of globalization and the ever-more competitive and volatile financial markets of the twenty first century.

With the integration of computer technology into the financial industry a level of efficiency and scalability to manufacture, propagate and facilitate the exchange of financial products globally is unprecedented in human history. From all the corners of the globe a security can be bought or sold by pressing a single button. Bill Gates wrote a book called “The speed of thought” in the early nineties and truly the speed with which a thought can be transferred into ownership of a security whether an asset, liability or a derivative is remarkable. But with this speed comes the peril of lack of information. The ability to effectively act in an informed manner and discern between a good trade and a trade promising only peril and misfortune in a market place which epitomizes the speed with which light can travel through a fiber optic cable is unfortunately little to none. No better place is this evident then the foreign exchange (FX) market where the vast majority of newly opened trading accounts (some estimate in excess of 85%) are depleted and are labelled internally by the brokerage firms as dormant or non-performing within the space of 12 months.

What are the determining factors of a successful trade? What are the determining characteristics of a successful trader? Alternatively, what are the determining factors of a losing trade? What are the determining characteristics of a consistently unsuccessful trader? What if all of these factors were measurable, quantifiable and easily implemented to enhance the performance of any trader, investor, portfolio or fund manager, professional or novice? What if we could further extrapolate these questions and answers into the design and management of portfolios of securities and entire investment funds, mutual funds and hedge funds? What if these same determining factors of success could be implemented institutionally through a securities exchange which facilitated equitable exchanges based on a common denominator? The seminal example of such an online trading system/platform is Neurotrader™ and that of a securities exchange platform is NeuroXchange™.

Utilizing scientific methods, principles and technological equipment which measures human biomarkers; coupled with our processes and advanced algorithms for assessing and determining psychophysiological states of performance we have developed a technology which enhances decision making performance and thereby perpetuates and instills a consistent basis for successful financial decision making within the context of a trading system/platform and a securities exchange facility which administers and supports improved financial decision making for all its' participants.

This service provides a safe, secure and effective means for financial market traders, investors, portfolio managers, fund managers and money managers (participants) to improve their decision making abilities, execute those decisions as timely orders and access a host of performance-based management tools facilitating a process-based methodology for consistent improvement toward the biological state of peak performance. For example, the Neurotrader™ system is comprised of four primary components: 1) Trader Assessment; 2) Trader Training; 3) Live Trading; and 4) Trader Evaluation. These four components allow a trader's biological state to be assessed and analyzed consistently using non-invasive, hard-wired and wireless biofeedback and neurofeedback devices. Further, these components allow for the implementation of a consistent training routine for enhanced biological performance, in constant relation to a specific objective, that being a “Peak Performance” state. And finally, this entire suite of components allows for peak performance based biomarkers to be quantified and assessed in relation to the task of trading, investing and portfolio/fund/money management.

Although the Neurotrader™ system alone is successful in eventuating a trader's psychophysiological state to a peak performance state whilst in context of real-life financial decision making we find that the power of this invention is truly seen when Neurotrader™ is coupled with a securities exchange facility such as NeuroXchange™. A psychophysiologically enhanced securities exchange such as NeuroXchange™ allows for the automatic mitigation of risk based upon the trader's psychophysiological state. Expressed another way, if a trader or fund manager is in a state of biological incongruence with the task of successful decision making, specific functions of the trading system and exchange facility can be turned off or on to limit the adverse effects of the poor decision making potential of the fund manager. This same series of events triggers Neurotrader™ to respond also with visual cues designed to alter the fund manager's psychophysiological state and guide the trader back into a state commiserate with peak performance.

### SUMMARY

In summation, the global financial markets and most, if not all of its' participants are in a continual state of uncertainty and instability in their day-to-day operations. This uncertainty leads to and exacerbates market volatility, as the markets are a reflection of our collective state of mind. We all know that national, regional and global economic prosperity relies on the stability of our financial system, the corner stone of which is the financial markets. By developing, implementing and propagating a system and method of increasing individual participant certainty and confidence through monitoring and altering the psychophysiology of each market participant so that it reflects all the more a state of peak performance provides for the ability to mitigate the reactive responses of irrational and illogical behavior motivated by states of panic, fear and greed within the market participant. This exemplary system and method precisely focuses on the underlying causes of market volatility, uncertainty which lie within the locus of control of each individual market participant. It is our own individual ability to control our emotional states and foster prosperity through certainty of self-control as opposed to being victims of our own unregulated emotional states of fear and greed.

To address this and/or other needs, the present inventor devised, among other things, systems, methods, hardware (wired and wireless), interfaces, software and algorithms that enhance the psychophysiological state of the trader, investor and fund manager in addition to providing real-time feedback whilst actively participating in the financial markets. The integration and application of this information is in the service of helping the participant attain an ever-improving and heightened state of a peak performance thereby facilitating improved decision making, mitigating risk and producing greater financial results and real rates of return.

The exemplary system also provides the means by which to improve the trader's/money manger's cognitive capacity by providing methods and processes to assess and train divided attention, working memory and processing speed. By matching current cognitive results to specific objectives we can further mitigate human performance risk. Furthermore, by having a consistent method for training cognitive performance we can better manage human potential and effectively anticipate the level of cognitive functioning requisite for the desired change in cognitive performance.

Yet another feature allows for the risk appetite of the trader and portfolio manager to be increased to better suit market expectations. By utilizing specialized methods, processes and algorithms we can clearly decrease the anxiety experienced by the trader thereby allowing the investor to increase his/her decision making performance beyond that currently experienced.

Ultimately, one or more of these or other disclosed embodiments and/or features provide improved decision making capabilities in mission-critical and non-mission-critical environments along with a securities exchange that fosters and enhances peak performance decision making states in the service of providing a more stable and secure global financial market.

According to an aspect of the present invention, there is provided a method of:
Collecting raw psychophysiological data from the participant (user) via non-invasive wireless or wired electronic equipment.
Transmitting the collected raw psychophysiological data to a local machine where the local machine has a memory, processor, storage capabilities and data transmission functionality.

According to an aspect of the present invention, there is provided a method comprising of:
A local database hosted on a local/client machine:
   Which provides a means of collecting, storing and processing psychophysiological data.
   A means of communicating and transmitting locally stored raw and processed psychophysiological data to a server database for storage, processing and further communication.
A multi-user database hosted on a centrally located server machine:
   A means of receiving locally stored raw and processed psychophysiological data from multiple client-side machines.
   A means of processing raw and processed psychophysiological data stored on the server creating real-time, pre and post decision making tools, aids, guides and functionalities for providing effective and improved financial market decision making performance via the transmission of peak performance algorithms for all participants whether individual and/or as a collective.
   A means of transmitting multi-user raw and processed psychophysiological data to individual client-side machines as usable pre, post and real-time financial market decision making information and algorithms.
   A means of collecting individual security and market data from other financial market venues, liquidity providers and market participants with the accompanying order execution details.
   A means of enacting, changing, altering, appending and improving: trading, portfolio, money, asset, liability and fund management based functionalities in response to the collected, stored, raw and processed individual and collective psychophysiological and market data.
   A means of initiating automated orders and market decisions based on the raw and processed individual and collective psychophysiological data and securities and market data.
A graphical user interface for displaying information pertinent to facilitating peak performance based trading methods, processes, activities, behaviors and actions on the client-side machines
   A means of displaying raw and processed psychophysiological data.
   A means of displaying individual security data, multiple security data and general market data including derivatives thereof.
   A means of displaying methods for:
      Assessing a participant's/user's (trader's) psychophysiological profile at various times.
      Training and improving the peak performance decision making capabilities of the participant/user.
      Monitoring the real-time peak performance of the participant whilst actively engaging in the financial markets.
      Evaluating the periodic performance of the participant as it relates to psychophysiological and financial performance.
      Creating and implementing scheduled activities for the successful engagement and activity of participating in the financial markets and operating with financial instruments.
      Improving the competency of key trading, portfolio, money and fund management disciplines.
      Risk profiling and matching.
      Creating, managing and adjusting individual peak performance profiles.

According to an aspect of the present invention, there is provided a means of:
Creating user specific performance reports.
   Which include and are not limited to:
      Individual peak performance reports.
      Group peak performance reports.
         Whereby all categories of reports differentiate between:
         Performance Goals
         Process Goals
         Psychophysiological Goals
         Psychophysiological Results
         Financial Goals
         Derivatives of the above
Creating empirically based suggestions to provide continual improvements in peak performance across all categories of interest and investigation.

According to an aspect of the present invention, there is provided a means to:
Assess the psychophysiological state and capacity of the trader/participant/user.
Train and improve the psychophysiological and cognitive performance capacity to an optimum individualized peak state.
Monitor the participant's psychophysiological performance within the financial markets and in relation to financial market operations.
Evaluate psychophysiological performance within the context of financial performance.
Create and adjust training protocols and interventions to better serve the participant's integrated peak performance psychophysiological and financial performance objectives.

According to an aspect of the present invention, there is provided a means to:
Create, implement and administer psychophysiological peak performance objectives.
Create, implement and administer trading objectives.
Create, implement and administer portfolio, fund, money, asset and liability objectives.
Measure performance results in terms of a multi-dimensional perspective, namely:
   1) Performance objectives
   2) Process objectives
   3) Psychophysiological objectives
   4) Financial objectives
Assess the psychophysiological profile of the end-client/investor.
Assess and couple an end-client/investor with the right fund or/and manager/trader based on the correlation of their individual psychophysiological profiles.
Quantify, assess and measure the psychophysiological profile of a trader/fund manager/participant as well as any individual securities, portfolios of securities and investment funds that they administer/manage or intend/are candidate to manage in the service of denoting the level of congruency between the two and the ability/expectancy to receive positive profitable results.
Formulate a better and more congruent allocation of securities between traders and managers.

According to an aspect of the present invention, there is provided a means to:
Train and improve the competency of key trading, investing, portfolio management and fund management disciplines.
Monitor and evaluate the competency of key trading, investing, portfolio and fund management disciplines.
Establish realistic market-based competency objectives.
Report the effectiveness of competency-based measures and interventions.
Propose strategies for improvements in participant competencies.

According to an aspect of the present invention, there is provided a means to:
Instill empirically-based, behaviors in the participant conducive to effective performance within the trading/market milieu.
Monitor effectiveness of competency-based disciplines and routines
Implement individualized reassessment and redesign into competency-based disciplines and routines to achieve predetermined peak performance objectives and intermediate milestones.

According to an aspect of the present invention, there is provided a means to:
Create an individual peak performance profile objective for each and every participant as well as on a collective basis on behalf of participants/teams.
Quantify current individual peak performance profiles.
Thusly, provide a ratio of peak performance effectiveness by correlating individual peak performance objectives with current individual peak performance profiles.

According to an aspect of the present invention, there is provided a means to:
Mitigate risk by correlating real-time individual peak performance profile of the participant with the individual's peak performance objectives and market sentiment/expectations.
Trigger trading and fund-based risk management measures to optimize trading and fund/portfolio performance based upon correlated individual peak performance profiles (as stated above).
Alter platform/user functionality based on the exhibited individual peak performance profile of the participant/user to minimize risk and accelerate profitability.
Initiate training functionalities to improve the individual peak performance profile of the participant/user to the level requisite for the trading task demands.
Facilitate selection of securities based on the correlated psychophysiological algorithms of the individual peak performance of the participant and the market/security profile.
Selecting/determining order entry efficiency and timing utilizing correlated individual peak performance profile of the participant and the market/security.
Facilitating more accurate estimation of the market/price direction of a particular security utilizing the correlated algorithms of the individual peak performance profile of the participant/user and the market/security.

### BRIEF DESCRIPTION OF DRAWINGS

FIG. 1 is a flow diagram of the typical/standard (contemporary) architecture for a securities exchange.

FIG. 2 is a flow diagram of an exemplary psychophysiologically enhanced securities exchange corresponding to one or more embodiments of the present invention.

FIG. 3 is a hierarchal diagram of an exemplary psychophysiologically enhanced trading system, process layers 1 & 2 corresponding to one or more embodiments of the present invention.

FIG. 4 is a flow chart illustrating one or more exemplary methods of operating a psychophysiologically enhanced trading system and corresponding to one or more embodiments of the present invention.

FIG. 5 is a flow chart of one or more exemplary methods of developing enhanced decision making potential and capabilities in human beings for and whilst engaged in financial market operations.

FIG. 6 is an illustration of an exemplary graphical user interface corresponding to one or more embodiments of the present invention.

### DETAILED DESCRIPTION OF EXEMPLARY EMBODIMENTS

The following description, which incorporates the figures and claims, describes and/or illustrates one or more exemplary embodiments of one or more inventions. These embodiments, offered not to limit but only to exemplify and teach the invention(s), are shown and described in sufficient detail to enable those skilled in the art to make and use the invention(s). Thus, where appropriate to avoid obscuring the one or more inventions, the description may omit certain information known to those of skill in the relevant art.

### Contemporary Trading System and Securities Exchange

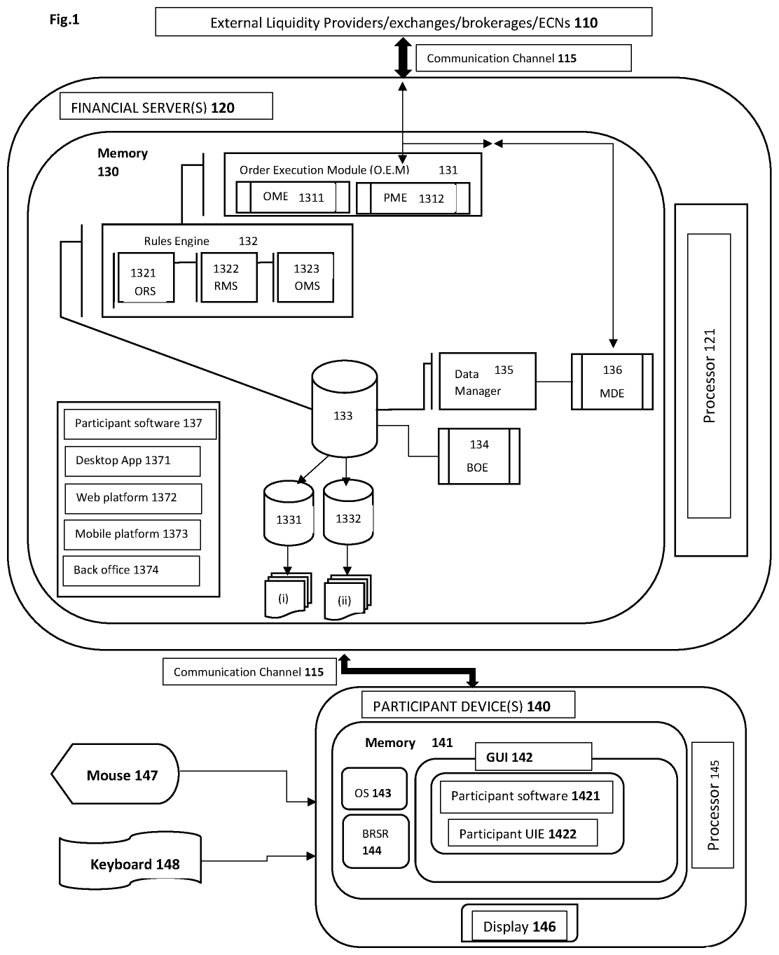

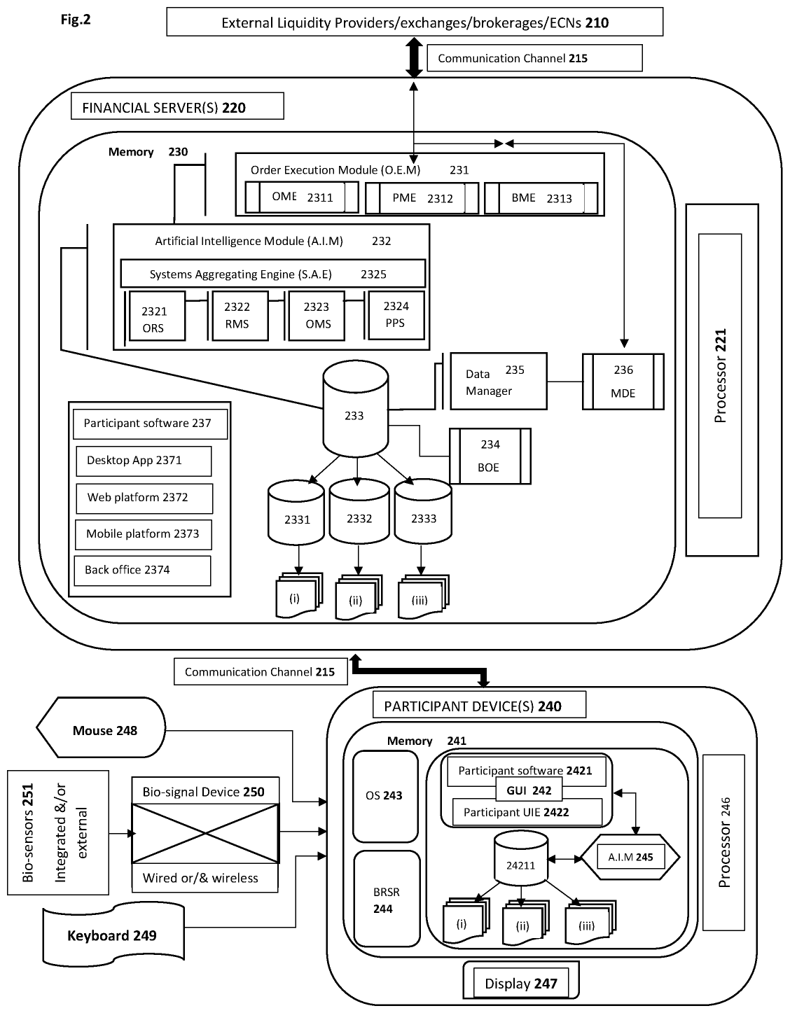

FIG. 1 depicts the components that comprise a contemporary securities exchange and trading system. This illustration has been presented in order to assist in the understanding of one or more embodiments of the present invention(s) and demonstrate the novelty of one or more embodiments of the present invention(s). Furthermore, by presenting the architecture of currently available technology in FIG. 1, the limitation of such contemporary technologies are better demonstrated which thereby allows for a better understanding of the capacity of which one or more embodiments of the present invention (FIG. 2/6) provide a viable solution.

Specifically, external liquidity providers, securities exchanges, brokerage facilities and ECNs (electronic communications networks) 110 provide access to larger numbers and a broad spectrum of users which further facilitates the transmittance of securities data, economic data, financial instrument data and financial entity data considered in part or in full as necessary in order to facilitate an exchange process of instruments from one participant to another. This data is transferred via an array of devices such as and not limited to personal computers, workstations, personal digital assistants, mobile phones, or any other device capable of providing an effective user interface with a server or database via wired or wireless technology/Communication Channel 115.

More specifically, participant device(s) 140 includes one or more processor(s) 145, a memory 141, a display 146, a keyboard (or keypad) 148, and a graphical pointer, selector or mouse 147. The processor 145 includes one or more processors, controllers, or processing circuits. Memory 141 includes software, such as participant software 1421 which further incorporates a set of one or more participant user-interface elements UIE(s) 1421, one or more operating system(s) 143 and a web browser 144. Participant software 1421 and participant UIE 1422 together define a graphical user interface (GUI) 142 that works in conjunction with keyboard 148, selector 147 and presented on display 146. One or more portions of GUI 142 enable the participant to not only view securities, financial and economic data but also to place orders for the purchase and sale of securities, communicate with other participants, and view back office features and functions 1374.

The functional and societal purpose of a securities exchange and trading system/platform is to facilitate the buying, selling, or otherwise enable the act of making transactions in one or more economic and/or financial instruments such as stocks, bonds, commodities, options, derivatives, cyber-currencies, cyber-instruments and so forth; from and for one or more specified or unspecified economic trading entities or parties such as individual investors, individual brokers, brokerage firms, retail banks, investment banks, mutual-funds operators, hedge-fund operators, etc.

Participant devices 140 are coupled or can be coupled, (for example, via an Internet Protocol (IP) network or other form of permanent, temporary, dedicated, shared wireless or wired communication link to a financial server) which in turn performs the function of a securities exchange, trading and/or brokerage platform.

### Contemporary Financial Server/Contemporary Securities Exchange

Financial server 120, which is generally representative of one or more servers for serving data in the form of webpages or other markup language forms with associated applets such as ActiveX controls, remote-invocation objects, or other related software and data structures to service clients &/or participants of various user profiles and requirements. Some financial servers will transmit data to and from the server using a version of the Financial Information Exchange (FIX) protocol. More particularly, server 120 includes a processor module 121, a memory module 130, an order execution module 131, rules engine 132, a database 133, a back office engine 134, data manager 135, market data engine 136 and participant software 137.

Processor module 121 includes one or more local or distributed processors, controllers or virtual machines.

Memory module 130, which may take the form of one or more electronic, magnetic or optical data-storage devices, stores a database 133 which further includes and/or incorporates a participant database 1331, and a financial database/securities database 1332, an order execution module 131 which further incorporates an order matching engine 1311 and a price matching engine 1312, a rules engine 132 which further incorporates an order routing system 1321, risk management system 1322, order management system 1323, a back office engine 134, data manager 135, market data engine 136 and participant software 137 which may include and take the form of a desktop application 1371, web platform 1372, mobile platform 1373 and a back office platform 1374. The contents of memory 130, such as software and/or data may be distributed across or replicated across different machines and/or systems.

Participant database 1331 generally includes participant related data (i) for controlling, administering and managing the purchase and sale of securities, managing pay-as-you-go or subscription-based or entitlement-based access to one or more databases or other features and functionalities for accessing the purchase and sale of securities accessible via or provided by server 120. Generally, participant database 1331 will include and not be limited to participant contact details, user authentication data and access/user rights, responsibilities, privileges and obligations and limitations etc.

Financial database 1332 includes securities, financial and economic related data (ii) for display to the user for analysis and consideration in making a decision to purchase or sell one or more securities.

The order execution module 131, also called a matching engine, facilitates the execution of buy and sell orders for securities based on different order types such as market, limit, stop, stop limit etc and via one of two methods; order matching and price matching. The order matching engine 1311 matches buy and sell orders for specified securities based on price and time priority. The price matching engine 1312 executes and fills the orders for specified securities when the price requested by a participant touches the price coming from another participant seeking to engage in a trade whether the price is internally or externally derived regardless of time.

The rules engine 132 has as its primary purpose that of administering and managing risk, both on a collective level in terms of the entire securities exchange and the individual level in terms of managing participant risk through the three core functional components of the rules engine which are the order routing system 1321, risk management system 1322 and the order management system 1323.

The order routing system 1321 plays a critical role when an external liquidity provider 110 is connected to the securities exchange/financial server 120. In such an environment the order routing system will transfer an order for a specified security to a venue that can match and fill the order to the specifications of the participant. The order routing engine serves as a means of risk management as well by allowing a securities exchange to pass a trade (buy or sell order) onto another exchange/venue to be filled thereby also passing on the associated risk exposure.

The risk management system 1322 is the core component which manages the risk of the securities exchange as it maintains the logic and parameters which define the rights, responsibilities and level of financial risk permissible for each individual participant, a collective of participants (geographical/demographic), collection of securities and also as a sum total risk for the securities exchange itself. These parameters can be adjusted at the discretion of the exchange, some can be enforced by governments and others can be implemented as a reflection of market volatility.

The order management system 1323 allows for the input/placing of orders into the system for routing, execution and filling to pre-established destinations whether pre-established by the participant, by the exchange or external liquidity provider. The order management system 1323 takes the order from the participant, parses it, validates it and either executes it using the order matching engine 1311 or the price matching engine 1312 or passes it on to the risk management system 1322 which then transmits the order to the order routing system for execution through another exchange/liquidity provider 110.

The back office engine 134 has back office, clearing and settlement functions to ensure fast and secure transaction processing for clearing and settlement. The system provides an interface to the participant with specific user privileges for conducting day-to-day operations such as participant search, account search, collateral search, collateral allocation, available collateral, risk allocation, risk exposure, open positions, closed positions etc and distribute this and other information further to requisite participants via participant devices 140.

The data manager 135 is the custodian of all tick data as well as the open, high, low and close (OHLC) data for all securities traded on and featured by the securities exchange.

The market data engine 136 collects all the tick data from the matching engine and/or external exchanges/liquidity providers 110 and stores it in tick as well as OHLC format. The market data engine disseminates the quotes stream in live or delayed format to the participant devices 140 based upon user rights and privileges as established and maintained in the database 133 and participant database 1331.

Participant software 137 provides for various versions of software which facilitate the display of securities data, account data, news feeds, technical analysis and fundamental analysis tools as well as the transmittance of orders to the server for execution and filling. Participant software generally serves one of two functions including trading and back office functions. Trading functionality can be provided in one of four ways based upon user requirements and technological preferences and as such usually takes the form of a desktop application 1371, web platform 1372 or mobile platform 1373. The Back office 1374 features data and information specific to administering back office functions such as account, risk and securities management tasks. The back office 1374 feature can also be displayed via desktop application, web platform or mobile platform.

### Exemplary Trading System and Securities Exchange

FIG. 2 depicts the components that comprise an exemplary securities exchange and trading system. This illustration has been presented in order to assist in the understanding of one or more embodiments of the present invention(s) and demonstrate the novelty of one or more embodiments of the present invention(s).

In contrast to the previous explanation of FIG. 1, this description and explanation will highlight the novelty of the invention(s), the limitations of contemporary systems and a description of the solution as provided by one or more embodiments of the invention, it will be presented in a comparative manner to the contemporary trading system and securities exchange presented in FIG. 1.

Specifically, external liquidity providers, securities exchanges, brokerage facilities and ECNs (electronic communications networks) 210 provide the same features, function and service to that provided in the contemporary present day solution (FIG. 1) apart from the fact that the exemplary trading system and securities exchange provides the means by which other external liquidity

providers/exchanges/brokerages/ECNs 210 can incorporate and facilitate psychophysiological trading, risk management and securities exchange functions by (1) establishing the infrastructure to accommodate and facilitate psychophysiological trading via participant devices 240 and communication channel 215 and (2) establishing the infrastructure to facilitate a transfer of psychophysiological data with the exemplary trading system and securities exchange through the communication channel 215 for advanced risk management analytics and psychophysiological trade execution features. All data streams are transferred via the same array of devices, (such as that described in FIG. 1) and are not limited to personal computers, workstations, personal digital assistants, mobile phones, and/or any other device capable of providing an effective user interface with a server or database via wired or wireless technology through Communication Channel 215.

More specifically, participant device(s) 240 includes one or more processor(s) 246, a memory 241, a display 247, a keyboard (or keypad) 249, a graphical pointer, selector or mouse 248, bio-sensors 251 and a bio-signal device 250. The processor 246 includes one or more processors, controllers, or processing circuits. Memory 241 includes software, such as participant software 2421 which further incorporates a set of one or more participant user-interface elements UIE(s) 2422, one or more operating system(s) 243 and a web browser 244. Participant software 2421 and participant UIE 2422 together define a graphical user interface (GUI) 242 that works in conjunction with keyboard 249, selector 248, bio-sensors 251 and a bio-signal device 250 and presented on display 247. The main distinction of one or more portions of GUI 242 is that it not only enables the participant to view securities, financial and economic data; but also to place orders for the purchase and sale of securities, communicate with other participants, and view back office features and functions 2374. This is similar to the contemporary trading system and securities exchange of FIG. 1 but with the additional exception that it provides the participant the unique opportunity to view his psychophysiological response to the market thereby allowing the user through interaction with the exemplary trading system and securities exchange to adjust their psychophysiological state to one that is more conducive to successful decision making via a set of peak performance algorithms that monitor, assess and provide noninvasive interventions in real time. Therefore it is our belief that the functional and societal purpose of a securities exchange and trading system/platform extends beyond facilitating of buying, selling, and/or otherwise enable transacting in one or more economic and/or financial instruments (such as stocks, bonds, commodities, options, derivatives, cyber-currencies, cyber-instruments and so forth) from and for one or more specified or unspecified economic trading entities or parties, (such as individual investors, individual brokers, brokerage firms, retail banks, investment banks, mutual-funds operators, hedge-fund operators, etc.) to do so in a manner that is conducive to the fair and equitable distribution of the world's global financial resources. This we achieve in our evidence-based design of one or more embodiments of the present invention with the purpose of providing a method for financial market participants to engage with the financial markets and enact trading-related decisions in a mental and physical state congruent with established and constantly evolving models of peak performance behaviors.

The method by which we enable the participant to engage with the financial markets in a peak state is through the use of bio-sensors 251 and bio-signal device 250. The exemplary trading system and securities exchange provides the means by which the participant attaches and/or is connected to one or more bio-sensors 251 which are either integrated to a bio-signal device 250 or connected via wired or wireless means to a bio-signal device 250 which in turn can be integrated into the participant device 240 or is a stand-alone device connected to the participant device 240 via wired or/and wireless technology for the transmittance of psychophysiological data from the participant.

The strength and novelty of one or more embodiments of the present invention can clearly be seen by the distinguishing technological enhancements made to the participant's experience as they engage with the financial markets and which is presented with the inclusion of bio-sensors 251, bio-signal device 250 and the process and features that are enhancements to the participant device 240; more specifically with the software enhancements necessary to enable the participant to achieve states of improved peak psychophysiological performance with the inclusion of a locally stored database 24211 and the artificial intelligence module 245. This method allows the participant to be receiving real-time psychophysiological assessments and cues which are correlated to the specific trading function being administered by the participant. At any point in time the participant is privy to 1) his/her psychophysiological response to the market/security, 2) a comparison of this state with that of a state of ideal peak performance and 3) a constant appraisal of current psychophysiological state in relation to each and every change in the price of a security and/or portfolio of securities.

Specifically, once the psychophysiology/bio signals are received from the participant by bio-sensors 251, transmitted to bio-signal device 250 for possible encoding, amplification, processing and filtering the signals are relayed to the database 24211 and stored in data file (iii) whilst in parallel, real-time market data is being received from server 220 via the communication channel 215 and fed into the participant database 24211 to be stored in a data file (ii). As these two sets of data are received they are being assessed and interpreted in real-time by the artificial intelligence module 245 locally stored on the participant device 240 which communicates these real-time results via elements of the participant UIE 2422, participant software 2421 collectively GUI 242 to the participant through the display 247. This process of communication of psychophysiological real-time information and market/securities data in an interactive manner is facilitated by selector 248 and keyboard/keypad 249.

Local database 24211 appends all data to the server database 233, (specifically to database 2333) on a periodic basis. Additionally, all data from the artificial intelligence module 245 is appended to the artificial intelligence module 232 on server 220 via communication channel 215. Artificial intelligence module 245 located on participant device is also appended with improved peak performance measures and algorithms by the artificial intelligence module 232 located on server 220.

Participant devices 240, (similar to those presented in FIG. 1) are coupled or can be coupled, for example, via an Internet Protocol (IP) network or other form of permanent, temporary, dedicated, shared wireless or wired communication link to a financial server. Said financial server would then in turn perform the function of an exemplary trading system and securities exchange or trading and/or brokerage platform transferring not only market based decision but the entire embodiment of raw and processed psychophysiological responses (data) and resulting algorithms from the participant and collective.

### Exemplary Financial Server/Exemplary Securities Exchange

Financial server 220, is generally representative of one or more servers and incorporates the same services, functions and features of the financial server presented in FIG. 1 with the enhanced inclusion of technology specific to the collection, storage and processing of psychophysiological data from one or more participants and from one or more servers. More particularly, server 220 includes a processor module 221, a memory module 230, an order execution module 231, and an artificial intelligence module 232 in lieu of the rules engine in FIG. 1. Essentially, server 220 incorporates a systems aggregating engine 2325 for processing peak performance data for improved risk management functionality, a database 233 which includes an additional database 2333 for collection and storage of raw, filtered and processed psychophysiological data, a back office engine 234, data manager 235, market data engine 236 and participant software 237.

Processor module 221 includes one or more local or distributed processors, controllers or virtual machines.

Memory module 230, which may take the form of one or more electronic, magnetic or optical data-storage devices, stores a database 233 which further includes and/or incorporates a participant database 2331, a financial database/securities database 2332, and a psychophysiology database 2333, (an order execution module 231) which further incorporates an order matching engine 2311, a price matching engine 2312 and a biomarker matching engine 2313. Instead of a rules engine 132 in FIG. 1 the exemplary invention incorporates an artificial intelligence engine 232 which consists of a systems aggregating engine 2325 which further incorporates an order routing system 2321, risk management system 2322, order management system 2323, a peak psychophysiology system 2324, a back office engine 234, data manager 235, market data engine 236 and participant software 237 which may include and take the form of a desktop application 2371, web platform 2372, mobile platform 2373 and a back office platform 2374. The contents of memory 130, such as software and/or data may be distributed across or replicated across different machines and/or systems real or virtual.

Participant database 2331 generally includes the same participant related data under (i) as with that represented in FIG. 1 (i) for controlling, administering and managing the purchase and sale of securities, managing pay-as-you-go or subscription-based or entitlement-based access to one or more databases or other features and functionalities for accessing the purchase and sale of securities accessible via or provided by server 220 with the inclusion of trading specific parameters, portfolio specific parameters, fund specific parameters, psychophysiology specific parameters and peak performance specific parameters which in communion formulate an “Individual Peak Performance Profile” for each and every participant.

Financial database 2332 and dataset 2322 (ii) includes the same series of data that is presented in FIG. 1 under 1332 and 1332 (ii) and additionally incorporates the individual participant and collective participant psychophysiological data time stamped for each and every traded security.

The order execution module 231, also called a matching engine, has the same features as in FIG. 1/131 with an order matching engine 2311 and a price matching engine 2312. The key feature differentiating the exemplary trading system and securities exchange is its ability to execute orders based upon specific psychophysiological biomarkers via the biomarker matching engine 2313. This distinguishing feature allows orders to be processed only when specific biomarkers/psychophysiological parameters/thresholds are met. This enables for the clear discernment between optimal and sub-optimal trades as well as the ability to process or deny orders based upon the ability or inability to meet predetermined psychophysiological thresholds for performance. Further, we anticipate the ability to facilitate complete buy and sell side orders of an individual trade purely based on the matching of biomarkers between the buyer and seller which is a major distinguishing factor of this technology

The power of this invention as a risk management tool is clearly visible with the functionality of the artificial intelligence module 232 acting as an advanced and adaptive learning logic which correlates, aggregates and computes the results of the system aggregating engine 2325 to produce evolving individual peak performance algorithms and collective peak performance algorithms in addition to formulating and evolving psychophysiological biomarkers indicative of specific securities and portfolios of securities. The system aggregating engine 2325 performs the invaluable task of collecting, aggregating and computing the results of the four components which comprise the risk management rules based engine involving the following: the order routing system 2321, risk management system 2322, order management system 2323 and the peak performance system 2324.

The order routing system 2321, (which maintains in principle the same functionality as that of its' counterpart in FIG. 1 [contemporary system] to transfer an order for a specified security to a venue that can match and fill the order to the specifications of the participant) has the additional benefit of being correlated with the psychophysiology of the individual participant and cross-correlated with the psychophysiology of the collective participants which allows meta-analysis to take place on both the individual and group levels. Furthermore, the order routing engine in the exemplary trading system and securities exchange provides the methodology to route orders based on the objectives of the participant. This is possible because the exemplary trading system and securities exchange maintains the participants trading objectives and statistics of success for specific trading actions and operations thereby presenting the participant with an evolving model of their own optimal trading methodology and strategy. In so doing, this system, allows for orders to be routed so as to facilitate and increase the congruency between the trading objective and market conditions/opportunities and threats.

The risk management engine 2322 also maintains the same features of its counterpart in FIG. 1 (contemporary system) by administering the parameters which define the rights, responsibilities and level of financial risk permissible for participants with the distinction that an individual's risk management as it relates to position sizing, margin/leverage and portfolio design is enhanced with the decision logic that weights risk as a product of psychophysiological performance state. As an example, in the exemplary trading system and securities exchange the psychophysiology of a participant is constantly monitored over various trading and portfolio functions. Over time empirical evidence shows a consistency for certain results to transpire out of specific psychophysiological states from the participant. This empirical evidence for each participant is stored in the database and maintained in the decision making logic of the risk management system. Therefore, a risk allocation for a specific trade in excess of the norm when the participant is in a peak psychophysiological state conducive to optimal decisions is enabled. Alternatively, system risk is elevated when the participant is in a maladaptive psychophysiological state, colloquially stated as being in a “fight or flight response,” or more scientifically, being dominated by the limbic and sympathetic systems to the extent that they are rendered biologically incapable of making clear, rational, and effective decisions. In this scenario the risk model for the individual participant is altered to reflect their psychophysiological state and in precarious scenarios buy and sell buttons could be disabled and positions could be automatically closed to stop what is known as “revenge trading” and “addiction-based actions” also known as “gambling” if the participant wishes. Furthermore, we can enact these same decision logic systems to propose various actions based upon the exhibited and recorded psychophysiology of the participant.

The order matching engine 2323 has the same base functionality of the contemporary system in FIG. 1 (which allows for the input/placing of orders into the system for routing, execution and filling). The point of distinction of this invention is that it not only takes the order from the participant, parses it, validates it via the risk management system prior to executing the order but in addition the participants' psychophysiology as a time-series event correlated to the decision making process and the action of placing the order is validated as being conducive or unconducive to optimal decision making prior to executing the trade. Additionally, this activity is recorded in the database with the corresponding trading result to further enhance the repository of decision making activity and the underlying psychophysiological state which produced the decision.

The peak performance system 2324 is constantly correlating and evolving the peak performance biomarkers of participants in parallel with price for specific securities and specific decision making events. Individual peak performance biomarkers are correlated and adjusted with resultant information from collective peak performance biomarkers and vice versa; thusly making for a robust, specific and constantly evolving empirically-based decision making logic and set of adaptive algorithms.

The back office engine 234 has the same back office, clearing and settlement functions as presented in the contemporary system in FIG. 1 to ensure fast and secure transaction processing for clearing and settlement. In addition, it provides the performance statistics of each participant or collection of participants as it relates to their psychophysiology, degree to which optimal states of psychophysiology were achieved, the decisions that were enacted and the corresponding psychophysiological state and financial results. The back office engine provides for easy assessment of necessary interventions whether individual psychophysiological training or systematic changes in risk profiles and risk management parameters. The resulting reports of performance are adjusted to suit user rights, privileges and limitations and are accessible via participant device 240.

The data manager 235 is the custodian of all tick data as well as the open, high, low and close (OHLC) data for all securities traded on and featured by the securities exchange in addition to being the custodian of all psychophysiological data.

The market data engine 236 collects all the tick and psychophysiological data from the order execution module 231 and/or external exchanges/liquidity providers 210 and stores it in tick as well as OHLC format. The market data engine disseminates the quotes stream in live or delayed format to the participant devices 240 based upon user rights and privileges as established and maintained in the database 233 and participant database 2331.

Participant software 237 provides for various versions of software as does the contemporary trading system and securities exchange in FIG. 1 which facilitates the display of securities data, account data, news feeds, technical analysis and fundamental analysis tools and also facilitates the transmittance of orders to the server for execution and filling. In addition, the exemplary trading system and securities exchange has the capacity to display the raw, filtered and processed psychophysiology of the participant, collection of participants, the peak performance biomarkers and thresholds of performance, as well as the biomarkers of individual securities and collections of securities further categorized by geography, time and other demographic features as real-time information or delayed. Similar to FIG. 1, participant software in the exemplary trading system and securities exchange generally serves one of two functions: trading functions (which includes portfolio and fund functionalities) or back office functions. Trading functionality can be provided in one of four ways based upon user requirements and technological preferences and as such usually takes the form of a desktop application 2371, web platform 2372 or mobile platform 2373. The Back office 2374 features data and information specific to administering back office functions such as account, risk and securities management tasks all with the additional benefit of displaying the psychophysiological data which originally created the back office results. The back office 2374 feature can also be displayed via desktop application, web platform or mobile platform.

### Methods of Operating the Exemplary Psychophysiologically Enhanced Trading System

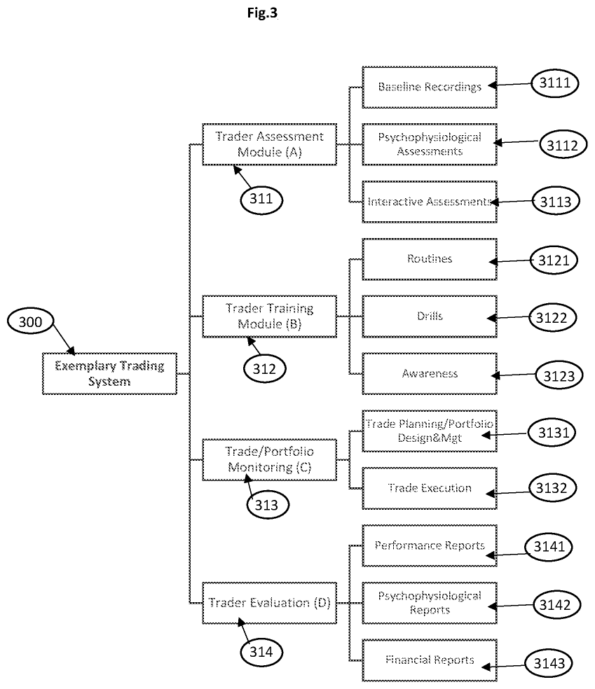

FIG. 3 shows a hierarchal diagram of one or more exemplary methods of operating one or more embodiments of a psychophysiologically enhanced trading system 300. It is important to note that the participant engages each of the elements of the psychophysiologically enhanced trading system 300 via the non-invasive participant device 240. Whilst engaged with the device 240 all psychophysiological data of the participant are being collected and recorded in the locally stored database 24211 and appended to databases 233 and 2333 located on the financial server 220 as illustrated in FIG. 2.

In the one or more embodiment(s) of a psychophysiologically enhanced trading system the exemplary methodology to operate is divided into four functioning components/modules (A, B, C, D); Trader Assessment Module (A) 311, Trader Training Module (B) 312, Trader/Portfolio Monitoring Module (C) 313, and Trader Evaluation Module (D) 314. These four functional components are further divided into a secondary layer of elements each of which embodies a selection of protocols facilitating the achievement of predetermined objectives for each element (secondary layer) and the objective of each of the four modules.

The Trader Assessment Module 311, has at its' core objectives to measure the psychophysiological state of the participant on a periodic basis. It firstly assists with providing a baseline recording prior to any introduction of stress to the participant followed by a recording of the participant under conditions of measured, induced duress. Both financial market related and non-financial market related stressors may be included as part of this assessment process. The objectives of the trader assessment module 311 are achieved with the creation and implementation of one or more functioning elements. In the exemplary methodology three functional elements have been created to suit this purpose; Baseline Recording 3111, Psychophysiological Assessments 3112 and Interactive Assessments 3113.

The core objective of the Baseline Recording element 3111, is to record and measure the trader's psychophysiological state with and without induced stressors. An important point to note is that the stressors induced upon the trader are non-trading related stressors and are neurological and biological in nature only. Conducting the baseline recording elements on a periodic basis allows for the management of the participant's efforts to achieve higher states of peak performance in everyday life and specifically whilst engaged in financial market operations. This allows us to clearly gauge strengths and weaknesses as well as the effectiveness of interventions.

The Psychophysiological Assessment element 3112 contains a series of stimuli which facilitate the development of a risk profile for both the participant (financial market operator) and for the end client/investor. This dual approach to risk profiling has been developed in order to better match an investor with a trader, and/or portfolio manager and fund manager who share the same psychophysiological response to risk and reward. Further, the Psychophysiological Assessment element 3112 provides the means by which the participant enters into the system their desired trading system user parameters which includes and is not limited to securities to be traded, leverage/margin requirements, position sizing parameters, general trading and risk parameters.

The Interactive Assessments elements 3113 consists of specialized biological and neurological stressors to gauge the participant's cognitive capacity in terms of working memory, divided attention, processing speed, executive functioning and shift focusing. All of which are essential and determining elements of successful decision making.

The Trader Training Module 312, is centralized around core objectives designed to facilitate the participant in the development of competencies associated with successful financial decision making, portfolio design, management and fund management. The core competencies of this exemplary system are indicative of the results of seven years of research and 18 years of financial market exposure and include; Routines 3121, Drills 3122, Awareness 3123. They are illustrative of one methodology and can be supplemented and exchanged with other means and methodologies.

The Routines element 3121 is comprised of a set of decision making protocols designed to train the brain and nervous system to execute relevant decisions systematically all whilst recording the psychophysiological state of the participant. Recording the psychophysiological state of the participant enables the management of the participant's stress response via real-time feedback. By engaging these elements with the aid of biofeedback and neurofeedback the participant can more readily acquire the behavioral tendencies and systematic methods of operations consistent with optimal performance. One additional way with which competency is gauged is by the degree to which a calm and relaxed disposition (psychophysiology) is experienced by the participant as they engage with the financial markets. With increases in the experience of this relaxed state during trading activities the participant edges all the closer to states of peak psychophysiology also known as peak performance states; an effortless state of optimal performance whilst consistently performing the same routine. Having the ability to measure the participant's psychophysiological state as they conduct competency specific routines and further train him/her toward those peak performance states allows for the rapid movement toward systematic peak human performance in financial market operations which in effect is the exemplary risk management solution.

The Drills element 3122 comprises a set of interrelated daily exercises designed to build task specific competencies. Each task is tailored to the specific function that the participant needs to learn and master as a competency to administer their job and role correctly; in effect minimizing the trading risk, portfolio risk and risk of the entire fund/institution. The tasks are organized as daily exercises conducted whilst recording and measuring the psychophysiological state of the participant, thereby utilizing the interactive nature of biofeedback and neurofeedback tools to enhance the learning process inherent in achieving peak states of performance. The daily regime also facilitates accelerated learning, practice, and maintenance of core competencies. Furthermore, with the core competencies being learned and recorded, an idiosyncratic baseline of performance is being established for each participant. Being able to ascertain in real-time when the psychophysiology of the participant has deviated above or below thresholds achieved in the Trader Training Module allows for systematic mitigation of trading privileges, functionalities and features, thusly serving multiple risk management purposes.

The Awareness element 3123 comprises a set of neurological and biological exercises developed to enhance reference frame awareness. Reference frame awareness is the ability and perceptual flexibility to shift in and out of different perceptual viewpoints, essential in successful financial market operations. As an example, a trader seeking an opportunity in a certain market or security needs the cognitive flexibility to view and assess the situation from many different timeframes. An obvious opportunity in the short term may not necessarily mean that particular security should be purchased and held for a long period of time. The same example can be viewed from the other vantage point which tells us that a long term trend of increased price (bullish trend) may not mean that the opportunity to buy is in the short term. Essentially, this is the function of the exercises of the Awareness element 3123, to build the cognitive flexibility requisite to view multiple securities and markets through different frames of awareness consistently, effortlessly and expediently.

The Trade/Portfolio Monitoring Module 313, has as its objective to develop, execute and manage risk exposure as it pertains to the purchase and sale of financial market and economic instruments for financial gain in context of predetermined performance objectives. The exemplary methodology further provides for two elements/sets of protocols that constitute the Trade/Portfolio Monitoring Module 313. The first being the Trade Planning/Portfolio Design & Management 3131 element whose purpose is to plan and design the optimal trading strategy and tactic as well as design and implement trades using strategies and tactics from the optimal portfolio of financial instruments all in context with the prevailing market conditions. Secondly, the Trade Execution 3132 element which is purposed to facilitate the participant in executing the strategies and tactics to completion within the context of prevailing market conditions.

The Trade/Portfolio Monitoring Module 313 achieves its objective of facilitating a methodology to develop, execute and manage risk exposure for optimal financial gain by constantly monitoring and measuring the psychophysiological response of the participant and correlating this response in real-time to pre-established, and constantly evolving peak performance thresholds. In the exemplary methodology, trading system and securities exchange it is common practice to recognize deviations in strategies and tactics by viewing deviations in the psychophysiological state of the participant which precede the market conditions. As an example in the participant's psychophysiological state prior to initiating a buy or sell order (moments before clicking the buy or sell button) is a key biomarker which provides an insight based upon the psychophysiological state experienced prior to the action. If, the participant is experiencing a state of psychophysiological stress beyond or below that determined as being optimal the deviation in their state from optimal is directly correlated to the disparity of the entry from the optimal entry point. In this instance, the exemplary methodology, trading system and securities exchange can mitigate risk by delaying the entry and instead initiating a peak performance conditioning routine which activates display cues to guide the participants' psychophysiology toward the predetermined peak performance thresholds prior to taking further market-based action. Further, the exemplary system can disqualify, decrease and increase the risk allocation or automatically initiate market actions like speeding up market entries as a direct response to the psychophysiological state of the participant. Because it is a common understanding that cognitive biases (head chatter) create indecision, doubt and impulsive reactions, (all of which are detrimental to effectively and consistently following a routine financial plan) this psychophysiologically-based risk mitigation system demonstrates the effectiveness of one or more embodiments of the present invention as an exemplary solution. The ability to maintain a clear, calm and alert state of mind in the midst of the dynamic market fluctuations is paramount to financial market success.

The Trade Planning/Portfolio Design & Management 3131 element is a sequential process of assessing market opportunities and threats within the context of pre-established objectives. This exemplary methodology draws its success from two key novel distinctions. Firstly, all processes that it contains to plan a trade, design a portfolio and manage both are sequential. That is, there is a pre-established systematic rules-based relational methodology which dictates and determines each element/event of the decision making process and the order by which said elements/events are presented for consideration and possible execution by the participant. Secondly, during the sequential process the psychophysiological response of the trader respective to each element/event/aspect of the process is being measured, recorded and analyzed. Being a sequential process that is quantified psychophysiologically as a stimulus and response data packet, allows for the precise measurement and pairing of the participants' psychophysiological state whilst enacting any one specific decision and/or action within the markets. This thereby allows for corrective action and feedback to be precise, which effectively and efficiently maximizes the participants' development toward predetermined objectives.

The Trade Execution 3132 element outlines the exemplary process whereby a strategy and tactic is initiated, monitored and brought to completion in parallel with the attainment of predetermined objective(s). This exemplary method ensures the participants' psychophysiological state is constantly being monitored and cross referenced in real-time with peak performance thresholds. For example, the triggering of any predetermined biomarkers initiates a response from the exemplary methodology either as a specific market-based action or an action to re-condition the participant toward a peak performance threshold, thereby allowing the participant to be actively engaged in a peak performing state whilst engaged in the financial markets. This parallel process increases the probability that the participant will have the perceptual clarity and cognitive power to enact the actions requisite to fulfilling optimal performance objectives.

The Trader Evaluation Module 314 has as its key objective to report financial performance as it is related to the psychophysiological state of the participant in as granular a form as possible thereby allowing for corrective actions to be element and biomarker specific. For example, the exemplary methodology presented here can capture singular thoughts and categorize them in terms of their relationship to predetermined objectives within the context of a specific process. Said objectives are formulated by the participant prior to taking financial market operations. The Trader Evaluation Module 314 consists of three elements, Performance Reports 3141, Psychophysiological Reports 3142 and Financial Reports 3143.

The Performance Reports 3141 element is an efficiency report. It reports the efficiency with which a participant was able to consistently implement the processes established in the exemplary methodology. Deviations in consistency from predetermined processes result in corresponding deviations from predetermined financial objectives. Therefore, a key indicator of performance and a key method for performance improvement is in real-time assessment and implementation of corrective behavior on behalf of the participant. Thusly, the participant can continue to implement the process which has been determined to achieve the desired objectives consistently in a state congruent with peak performance psychophysiological state.

Psychophysiological Reports 3142 element illustrates the extent to which the participant was able to achieve and maintain a peak performance state whilst engaging one or more embodiments of the present invention. It also illustrates the change in the participants' psychophysiological state for the same protocols and elements over time thereby showing long-term changes in performance which allows for further insight into what corrective actions and procedures may be beneficial.

The financial reports 3143 element illustrates financial results of the participant in relation to the predetermined objectives of the participant.

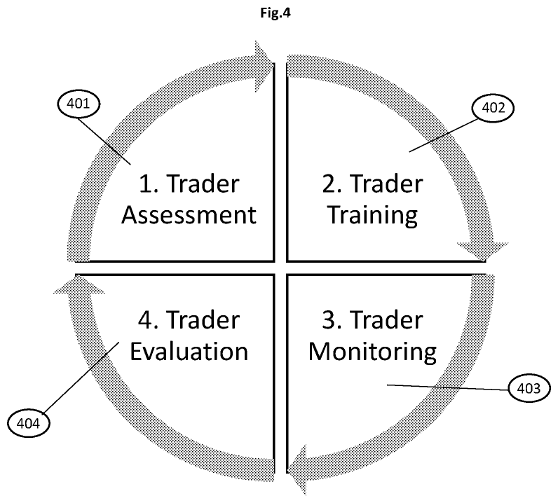

FIG. 4 shows a flow chart illustrating the general overview of one or more exemplary methods of operating a psychophysiologically enhanced trading system. This simplified visual image shows the exemplary methodology of operating one or more embodiments of the present invention whereby a constant cycle and feedback loop, commencing with an initial psychophysiological assessment of the participant, provides for a basis upon which to conduct a systematic process of training, in effect building competencies. Competencies are developed by measuring the psychophysiological response of the participant whilst conducting task-specific and objective-orientated decisions which provide for quantified goals for the participant in live market conditions (whether real or simulated). The effects of the training and performance goals embodied within the training component are tested in the Trade Monitoring component which then conducts an evaluation of the participant. The evaluation component compares predetermined goals with actual performance results in terms of holistic performance results, psychophysiological results and financial results. Following the completion of one cycle of the exemplary methodology, the participant will be re-assessed, providing a measure of relative change in comparison to the initial assessment (prior Trader Assessment). This will in effect provide a measure of change in participants' psychophysiology relative to the initial baseline recordings. Reassessment relative to the initial baseline perpetuates, through increased insight, a necessity to further implement a new set of trader training protocols, thereby facilitating a perpetual feedback loop of peak performance training relative to pre-established and quantifiable objectives, (whether they be psychophysiological biomarkers, performance objectives, financial objectives or a combination off all three).

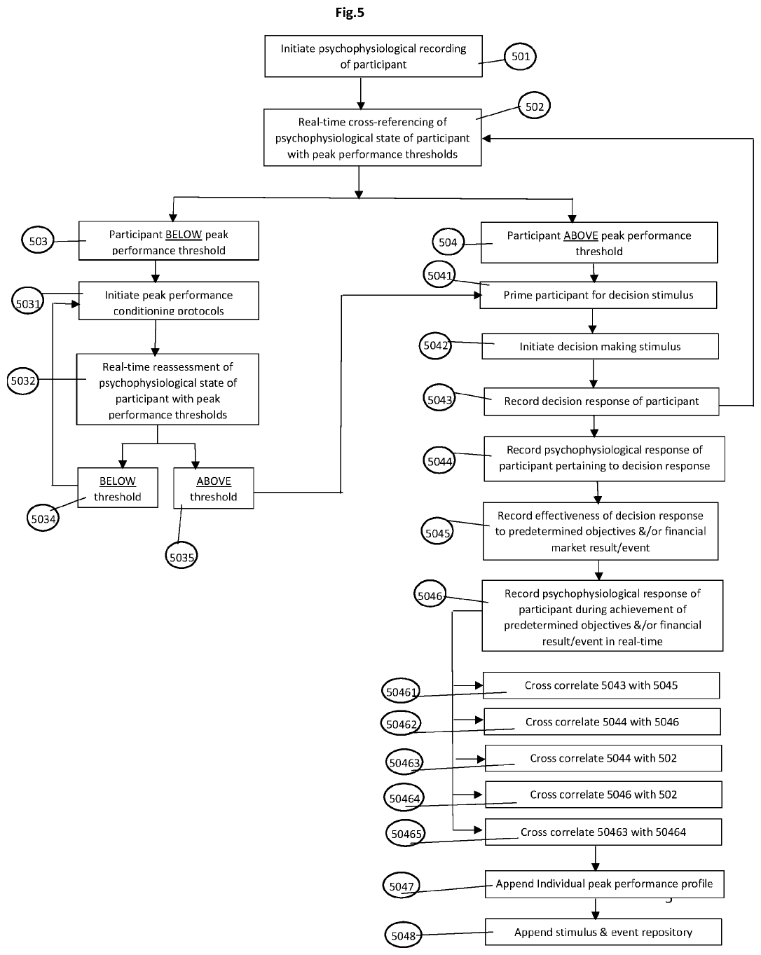

FIG. 5 is a flow chart of one or more exemplary methods of developing enhanced decision making potential and capabilities in participants whilst engaged in financial market operations. This exemplary methodology is applicable to one or more embodiments of the present invention. Further, it is used in one or more of the exemplary methods of operating one or more embodiments of a psychophysiologically enhanced trading system 300 as illustrated in FIG. 3.

The methodology commences with element 501 where a participant is connected to device 240, while interacting with GUI 242 which is connected to the financial server 220 via communication device 215. Upon receiving a recording with valid duration and quality from the participant the psychophysiological data from the participant is cross-referenced in real-time with the peak performance thresholds and parameters maintained locally within A.I.M 245 and on the server A.I.M 232 for validation of whether the psychophysiological state is congruent with peak performance element 504 or not (element 503). If the participants' psychophysiological state is incongruent, that is, below the predetermined peak performance thresholds 503 then the exemplary system initiates peak performance conditioning protocols 5031 designed to modify the psychophysiological state of the participant toward desired thresholds. Whilst the peak performance conditioning protocols are being administered, real-time assessment for congruency are being automatically initiated (5032) which validates that the participant has either entered into a state of peak performance or gone above or below peak performance thresholds 5035. This process of determination initiates automated priming for decision making stimulus 5041. In the event that the participant is considered to be below the peak performance threshold at 5034 the peak performance conditioning protocols are continued until peak performance thresholds are met or fatigue is registered in the psychophysiology of the participant by A.I.M 245 and the exemplary user experience/participant session is ended. When a participant meets and/or exceeds the peak performance thresholds 504 or 5035 and the participant is primed for decision stimulus in 5041, the system initiates a decision making stimulus 5042 the participant decision response is recorded 5043 and the corresponding psychophysiological response is also recorded 5044. The decision response is tested in effectiveness according to predetermined objectives and/or financial market results/event(s) 5045 and finally, the psychophysiological response of the participant is recorded whilst the objective is completed 5046. With these results stored in memory a series of correlations are made, namely: 50461 the decision response of the participant 5043 is correlated with the effectiveness of the decision 5045; 50462 the psychophysiological response of the participant during the point of decision 5044 is correlated against the psychophysiological response of the participant upon completion of the decision making objective/fulfillment of decision objective; 50463 the psychophysiological response of the participant pertaining to the decision response is correlated with peak performance thresholds 502; 50464 the psychophysiological response of the participant at the time of the completion of the objective 5046 is correlated with peak performance thresholds 502; and 50465 the correlated psychophysiological recordings of the decision state 50463 of the participant and the resulting state 50464 are correlated. The correlated results are appended to both the individual peak performance profile of the participant 5047 and the collective stimulus and event repository for cross-referencing between participants 5048.

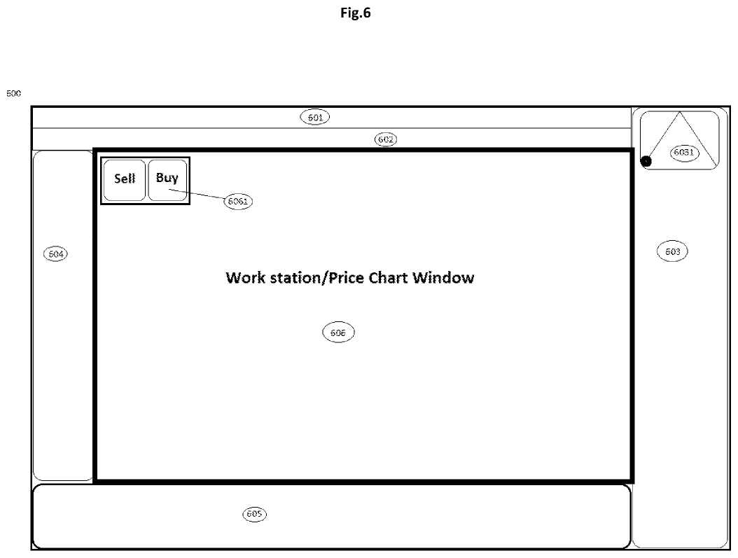

FIG. 6 is a depiction of an exemplary graphical user interface corresponding to one or more embodiments of the present invention whereby 601 represents an application specific toolbar, menu bar/ribbon; 602 represents a process/layer specific toolbar, menu bar/ribbon and is the means by which navigation through the series of exemplary methods occurs; 603 represents a portion of the GUI which displays psychophysiological-based perceptual cues (psychophysiological feedback panel). Serving as an exemplary example, 6031 illustrates one such method, consisting of a breathing pacer which assists the participant to maintain a constant breath rate corresponding to a peak performance state and one that reflects coherence with the participants' optimal heart rate. Element 604 represent a portion of the GUI dedicated to displaying and navigating trade/portfolio and fund management information; 605 is the performance and process objectives window which displays the participants' performance in relation to the specific element of the process presently engaged; within the context of the entire process and methodology comprising the exemplary financial decision making process both in terms of the degree to which peak performance states and thresholds are being met; 606 is the work station window which displays securities price data, financial and economic information, process-specific stimuli in the service of facilitating the participants' decisions; 6061 is the execution button designed to initiate the purchase and sale of securities, (which is the primary objective of any trading system and securities exchange). The distinguishing factor of the exemplary trading system and securities exchange as demonstrated by one or more embodiments of the present invention is to facilitate the purchase and sale of securities when the psychophysiological state of the participant is beneficial to success, that is, in a peak psychophysiological state.

1-23. (canceled)

24. A method comprising:
collecting psychophysiological data from a participant engaged in a financial operation with a trading system via a user interface;
comparing a metric associated with the psychophysiological data to a threshold value; and
enhancing a psychophysiological state of the participant in response to a determination that the metric associated with the psychophysiological data is below the threshold value.

25. The method of claim 24, wherein the enhancing comprises initiating a conditioning protocol that includes activating display cues on the user interface.

26. The method of claim 24, further comprising monitoring a subsequent psychophysiological state of the participant during the enhancing, wherein the enhancing is maintained while the metric associated with the psychophysiological data remains below the threshold value.

27. The method of claim 24, further comprising delaying a financial transaction in response to the determination that the metric associated with the psychophysiological data is below the threshold value.

28. The method of claim 24, further comprising determining the threshold value based on participant-specific psychophysiological data associated with past financial transactions of the participant.

29. The method of claim 24, further comprising determining the threshold value based on group-specific psychophysiological data associated with past financial transactions of a plurality of participants.

30. A method comprising:
collecting psychophysiological data from a participant while the participant is engaged in a financial operation with a trading system, the psychophysiological data including biomarkers associated with a current psychophysiological state of the participant;
quantifying a difference between the biomarkers associated with the current psychophysiological state of the participant and biomarkers associated with a peak psychophysiological state; and
determining whether to trigger an exchange of a security between the participant and a second participant, the determining based on the difference between the biomarkers associated with the current psychophysiological state of the participant and the biomarkers associated with the peak psychophysiological state.

31. The method of claim 30, wherein the determining of whether to trigger the exchange is based on at least one biomarker associated with the security.

32. The method of claim 31, further comprising associating the at least one biomarker with a type of security based on participant-specific psychophysiological data associated with past financial transactions of the participant.

33. The method of claim 31, further comprising associating the at least one biomarker with a type of security based on group-specific psychophysiological data associated with past financial transactions of a plurality of participants.

34. The method of claim 30, wherein the determining of whether to trigger the exchange comprises comparing a participant-defined permissible difference with the difference between the biomarkers associated with the current psychophysiological state of the participant and the biomarkers associated with the peak psychophysiological state.

35. The method of claim 30, wherein the determining is based on a current psychophysiological state of the second participant.

36. The method of claim 35, wherein the determining further comprises quantifying a difference between biomarkers associated with the current psychophysiological state of the second participant and biomarkers associated with a peak psychophysiological state of the second participant.

37. A method comprising:
collecting psychophysiological data from each of a plurality of participants engaged in a financial operation with a trading system, the plurality of participants including a first participant indicating a desire to sell a security and a second participant indicating a desire to buy the security;
performing a determination of whether each of the first participant and the second participant are in a peak psychophysiological state, the determination based on a comparison of psychophysiological data respectively collected from each of the first participant and the second participant with a psychophysiological threshold; and
facilitating an exchange of the security between the first participant and the second participant only if each of the first participant and the second participant are in a corresponding peak psychophysiological state.

38. The method of claim 37, wherein the determination is based on a biomarker of the psychophysiological data corresponding to the security associated with the financial operation.

39. The method of claim 37, wherein the determination is based on participant-specific psychophysiological data associated with past financial transactions.

40. The method of claim 37, wherein the determination is based on group-specific psychophysiological data associated with past financial transactions.

41. The method of claim 37, further comprising executing the exchange.

42. The method of claim 37, further comprising individually evolving at least one of the corresponding peak psychophysiological state of the first participant or the corresponding peak psychophysiological state of the second participant.

43. The method of claim 37, further comprising associating at least one of the corresponding peak psychophysiological state of the first participant or the corresponding peak psychophysiological state of the second participant with a collective peak performance.
